(19) United States
(12) Patent Application Publication
(10) Pub. No.: US 2006/0129441 A1
(43) Pub. Date: Jun. 15, 2006

(54) Apparatus, method, and system for documenting, performing, and attesting to internal controls for an enterprise

(75) Inventors: Steve Yankovich, San Jose, CA (US); Nathan Hoover, Los Gatos, CA (US); Benjamin True, Scotts Valley, CA (US); Brandon Lowell Duncan, San Jose, CA (US); Bronson Silva, Campbell, CA (US)

Correspondence Address: PATENTRY, 300 MURCHISON DRIVE, SUITE 218, MILLBRAE, CA, 94030, US

(73) Assignee: Movaris Inc., Cupertino, CA (US)

(21) Appl. No.: 10/710,433

(22) Filed: Jul. 10, 2004

(51) Int. Cl. G05B 19/418; G06F 15/02; G06F 3/00

(52) U.S. Cl. 705/8; 705/9; 715/700

(57) ABSTRACT

A system that creates documentation of internal controls for a business to meet its financial and legal obligations. The method of using the documentation itself to automate the actions assigned by the documentation to specific performers which actions can be tracked and measured enables management and audit personnel to assert and attest to its quality, reliability, and consistent usage. A business process management framework which easily adapts to any company's complex installed enterprise software environment to establish an automated, repeatable, and trackable process of complying with SEC rules for financial reporting according to Sarbanes-Oxley federal legislation.

### TECHNICAL FIELD

### Field of the Invention

The invention relates generally to computer software program products and more particularly to automation of enterprise, public entity, and corporate governance, documentation, reporting, and management of financial controls such as mandated in the Sarbanes-Oxley Act of 2002 and similar requirements of regulatory bodies.

Definitions

The description of the invention will utilize certain terms of art known to those skilled in the practice of audit, public accounting, corporate governance, internal controls, financial management, and financial reporting. The following terms are taken from references and incorporated herein for convenience for use in the claims.

Sources/References:

1. COSO ERM Framework; page 33.
2. Sarbanes-Oxley and the New Internal Audit Rules; Robert Moeller; page 135.
3. Source: Internal Control—Integrated Framework (Executive Summary); COSO ERM Framework.
4. Source: How to Comply with Sarbanes-Oxley Section 404; Michael Ramos; page 134.
5. Source: Evaluating Internal Controls by Ernst & Young
6. Financial Accounting by Robert Eskew and Daniel Jensen
   Definitions
   COSO The Organization

COSO is a voluntary private sector organization dedicated to improving the quality of financial reporting through business ethics, effective internal controls, and corporate governance. COSO was originally formed in 1985 to sponsor the National Commission on Fraudulent Financial Reporting, an independent private sector initiative which studied the causal factors that can lead to fraudulent financial reporting and developed recommendations for public companies and their independent auditors, for the SEC and other regulators, and for educational institutions.

COSO Enterprise Risk Management Framework

Recognizing the need for definitive guidance on enterprise risk management, COSO initiated a project to develop a conceptually sound framework providing integrated principles, common terminology and practical implementation guidance supporting entities' programs to develop or benchmark their enterprise risk management processes. A related objective is for this resulting framework to serve as a common basis for managements, directors, regulators, academics and others to better understand enterprise risk management, its benefits and limitations, and to effectively communicate about enterprise risk management issues.

Enterprise Risk Management (ERM)

Enterprise risk management is a process, effected by an entity's board of directors, management and other personnel, applied in strategy setting and across the enterprise, designed to identify potential events that may affect the entity, and manage risks to be within its risk appetite, to provide reasonable assurance regarding the achievement of entity objectives. The underlying premise of enterprise risk management is that every entity, whether for-profit, not-for-profit, or a governmental body, exists to provide value for its stakeholders. All entities face uncertainty, and the challenge for management is to determine how much uncertainty the entity is prepared to accept as it strives to grow stakeholder value. Uncertainty presents both risk and opportunity, with the potential to erode or enhance value. Enterprise risk management provides a framework for management to effectively deal with uncertainty and associated risk and opportunity and thereby enhance its capacity to build value. Enterprise risk management consists of eight interrelated components. These are derived from the way management runs a business, and are integrated with the management process. The components are: Internal Environment, Objective Setting, Event Identification, Risk Assessment, Risk Response, Control Activities, Information and Communication, and Monitoring.

Internal Control Integrated Framework

The report entitled “Internal Control Integrated Framework”, was commissioned by the Committee on Sponsoring Organizations of the Treadway Commission commonly referred to as COSO. It establishes a common definition of internal control that services the needs of different parties for not only assessing their control systems, but also determining how to improve them.

Internal Control

Internal control is broadly defined as a process, effected by an entity's board of directors, management and other personnel, designed to provide reasonable assurance regarding the achievement of objectives in the following categories: Effectiveness and efficiency of operations, Reliability of financial reporting, Compliance with applicable laws and regulations. Internal control consists of five interrelated components. These are derived from the way management runs a business, and are integrated with the management process. The components are: Control Environment, Risk Assessment, Control Activities, Information and Communication, and Monitoring.

Control Objective

Control Objectives are quantifiable, measurable, achievable business goals. Within this context, Control Objective relates to the preparation of reliable published financial statements, including interim and condensed financial statements and selected financial data derived from such statements, such as earnings or Net Asset Value (NAV). Within the context of COSO, objectives can be Strategic, Operational, Reporting or Compliance related in nature.

Operations Objectives

Operations objectives relate to the effectiveness and efficiency of the entity's operations. They include related sub-objectives for operations, directed at enhancing operating effectiveness and efficiency in moving the enterprise toward its ultimate goal. Operations objectives need to reflect the particular business, industry and economic environments in which the entity functions. The objectives need, for example, to be relevant to competitive pressures for quality, reduced cycle times to bring products to market or changes in technology. Management must ensure that objectives reflect reality and the demands of the marketplace, and are expressed in terms that allow meaningful performance measurements. A clear set of operations objectives, linked to sub-objectives, is fundamental to success. Operations objectives provide a focal point for directing allocated resources; if an entity's operations objectives are not clear or well conceived, its resources may be misdirected.

Reporting and Financial Reporting Objectives

Reliable reporting provides management with accurate and complete information appropriate for its intended purpose. It supports management's decision making and monitoring of the entity's activities and performance. Examples of such reports may include results of marketing programs, daily sales flash reports, production quality, and employee and customer satisfaction results. Reliable reporting provides management reasonable assurance of preparation of reliable reports for external dissemination. Such reporting includes financial statements and footnote disclosures, management's discussion and analysis, and reports filed with regulatory agencies.

Compliance Objectives

Entities must conduct their activities, and often take specific actions, in accordance with relevant laws and regulations. These requirements may relate to markets, pricing, taxes, the environment, employee welfare and international trade. Applicable laws and regulations establish minimum standards of behavior, which the entity integrates into its compliance objectives. For example, occupational safety and health regulations might cause a company to define its objective as, “Package and label all chemicals in accordance with regulations.” In this case, policies and procedures would deal with communication programs, site inspections and training. An entity's compliance record can significantly either positively or negatively affect its reputation in the community and marketplace.

Top-Level Reviews

Management at various levels should review the results of performance, contrasting those results with budgets, competitive statistics, and other benchmark measurements. Management actions to follow-up on the results of these top-level reviews and to take corrective action represent a control activity.

Direct Functional or Activity Management

Managers running functions or activities review operational reports. A manager responsible for a bank's consumer loans reviews reports by branch, region and loan (collateral) type, checking summarizations and identifying trends, and relating results to economic statistics and targets. In turn, branch managers receive data on new business by loan-officer and local-customer segment. Branch managers also focus on compliance issues, reviewing reports required by regulators on new deposits over specified amounts. Reconciliations are made of daily cash flows, with net positions reported centrally for overnight transfer and investment.

Information Processing

A variety of controls are performed to check accuracy, completeness and authorization of transactions. Data entered is subject to on-line edit checks or matching to approved control files. A customer's order, for example, is accepted only after reference to an approved customer file and credit limit. Numerical sequences of transactions are accounted for; exceptions are followed up and reported to supervisors. Development of new systems and changes to existing ones are controlled, as is access to data, files and programs.

Physical Controls

Equipment, inventories, securities, cash and other assets are secured physically and periodically counted and compared with amounts shown on control records.

Performance Indicators

Relating different sets of data—operating or financial—to one another, together with analyses of the relationships and investigative and corrective actions, serves as a control activity. Performance indicators include, for example, staff turnover rates by functional unit. By investigating unexpected results or unusual trends, management identifies circumstances where an insufficient capacity to complete key processes may mean that objectives have a lower likelihood of being achieved. How managers use this information—for operating decisions only, or to also follow up on unexpected results reported by external financial reporting systems—determines whether analysis of performance indicators serves operational purposes alone or external financial reporting control purposes as well.

Segregation of Duties

Duties should be divided or segregated among different people or functions to reduce the risk of error or inappropriate actions. This is a basic and important internal control procedure.

Preventive, Detective, and Corrective Control Classifications

Controls can be designed to either 1) Identify errors as they occur and prevent them from further processing; or 2) Detect and correct errors that already have entered the system. There are trade-offs for each approach. Preventive controls are more timely and help ensure that errors are never recorded in the accounting records to begin with. Detective controls may be cheaper to design and perform but are performed after the fact, potentially compromising the accounting system for extended periods of time. Both types of controls contain both an error detection and correction component.

Control Impact

Controls have varying degrees of importance within companies. Companies must distinguish between routine, key, and entity level controls. Routine controls, by themselves, are considered less material in nature than key or entity level controls thus having less impact. It is critical for companies to identify this impact level for their controls in order to prioritize which controls need constant monitoring, testing, and evaluation. This ensures that company resources are utilized in the most efficient manner and that proper attention is given to areas of higher risk.

Control Evaluation

In order to maintain an adequate internal control infrastructure, all standards (and now law) prescribe that management should regularly evaluate the effectiveness and efficiency of the controls that have been instituted. There are various methods by which management would perform Control Evaluations including Control Self Assessment, Peer Review, and Internal Audit work-plans. The goal of a Control Evaluation is to determine if the Control properly mitigates the associated risk and if it is efficient in doing so. It is necessary to determine if the control should be kept as is, modified or replaced.

Control Test

A Control Test is an activity performed for a particular control that will provide evidence to enable management to determine if that control is operating effectively. There are a number of factors that go into determining what type of test is performed, how often, by whom, and to what extent.

Accounting Process

In general, the Accounting Process entails identifying, measuring, recording, and communicating economic information to permit informed judgments and decisions by users of the information. In order to achieve this objective, individual Accounting Processes are established for the significant accounts of an organization. Collectively, these individual Accounting Processes exist to enable the overall Accounting Process.

Accounting Sub-Process

At a more detailed level, sets of rules and procedures, each called an Accounting Sub-Process, is defined for specific accounts to achieve the aforementioned for each Accounting Process.

Risk

Risks are potential or existing barriers to achieving Control Objectives.

Control (Control Activity or Control Point)

A Control is a process or activity put in place within the business to manage risks. Controls can be set up to run automatically within systems or can be manually performed by employees on a regularly scheduled basis or as needed. Controls can also be designed to prevent risks from occurring or for detecting and correcting problems as or shortly after they occur. Controls can be of varying degree of importance depending on the risk that the control is designed to mitigate and at what level in the organization the control resides. Controls are also referred to as Control Points which as the term implies, are designed to mitigate risks at specific points in a process or at a critical review time.

Control Definition

Control Definition is the end result of a process of determining and documenting how, when, and by whom the Control is to be performed. The Control Definition includes either general guidance or specific rules for performing the control and determining whether or not the risk has been properly mitigated.

Control Self-Assessment

Control Self-assessment is a method of control review by which a company can evaluate control effectiveness. These assessments are generally performed by employees that are involved in the actual process that is being assessed. Self-assessments allow companies to empower individuals to evaluate the effectiveness of their own control assignments. This is particularly important as control theory evolves to a decentralized approach where all employees should have a role in properly controlling a company.

Remediation

Remediation is a process by which controls deemed ineffective through evaluation, assessment, or testing are improved or replaced in order to properly mitigate their associated risk. This process needs to be well documented and can also lead to a public disclosure if the control ineffectiveness was judged to be of a material nature.

Exception

An exception is an outcome of a control evaluation in which the control is determined to not be functioning as originally designed. An exception by itself does not necessarily indicate a control breakdown. Judgment is rendered to determine if a remediation is necessary.

Monitoring

Internal control systems need to be monitored—a process that assesses the quality of the system's performance over time. This is accomplished through ongoing monitoring activities, separate evaluations or a combination of the two. Ongoing monitoring occurs in the course of operations. It includes regular management and supervisory activities, and other actions personnel take in performing their duties. The scope and frequency of separate evaluations will depend primarily on an assessment of risks and the effectiveness of ongoing monitoring procedures. Internal control deficiencies should be reported upstream, with serious matters reported to top management and the board.

Auditor Control Objective

An Auditor Control Objective is slightly narrower in scope than a Business or Control Objective and has a different purpose. An Auditor Control Objective is a goal that an external auditor would test against to ensure that numbers generated by a particular process were accurately arrived at and materially correct. If the auditor determines through testing that the Auditor Control Objective has been met, the auditor can then rely on the materiality of the numbers without manually calculating and tallying every transaction within the process.

Standard Errors (or Assertions)

Financial statement amounts and disclosures embody what are known as financial statement assertions. These assertions are further collectively broken down into various assertions or standard errors, characteristics of accuracy over the financial statements amounts and disclosures e.g. Does the asset exist (existence)? Did the transaction occur (occurrence)?.

Financial Statement Accounts

Financial Statement Accounts are those accounts that are listed on the Financial Statements for the purpose of reporting on economic performance and status of a business entity as a whole, prepared for all decision makers outside the company.

References

A reference is a piece of work, either a narrative or diagram, containing useful information that an employee or auditor can utilize (or refer to) if needed while performing control related activities.

Unqualified Attestation

In the context of Sarbanes-Oxley Section 404, an Unqualified Attestation is an External Auditor's communication of a positive conclusion about the reliability of management's assessment of the effectiveness of the company's internal control over financial reporting. An Unqualified Attestation is given only when there are no identified material weaknesses and when there have been no restrictions on the scope of the auditor's work.

COSO Definition of Internal Control

Internal control is a process, effected by an entity's board of directors, management and other personnel, designed to provide reasonable assurance regarding the achievement of objectives in the following categories: Effectiveness and efficiency of operations, Reliability of financial reporting, Compliance with applicable laws and regulations

### BACKGROUND ART

Key Concepts

Internal control is a process. It is a means to an end, not an end in itself. Internal control is effected by people. It's not merely policy manuals and forms, but people at every level of an organization. Internal control can be expected to provide only reasonable assurance, not absolute assurance, to an entity's management and board. Internal control is geared to the achievement of objectives in one or more separate but overlapping categories. Multinational, diversified public corporations may have in excess of 1000 control objectives in management accounting, financial reporting, and compliance with legal requirements. Supporting each objective are multiple procedures and controls. A company may have many thousand controls, which may be applicable daily, weekly, monthly, or quarterly according to their risk and benefit to the shareholders. It is traditional that, guided by external auditors, the CFO and his staff created policies and procedures in printed paper form which merely documented controls, what were best practices, without absolutely making sure that all employees followed the policies through. These were referred to as the control binders. Testing the effectiveness and implementation of these best practices consisted of periodic meetings between performers and auditors to verbally confirm that the policies were established, still applicable, and followed. Staying in compliance by ensuring that all of these control activities are executed, remediating errors, and attesting to their correctness is now mandated by SEC rules implementing the Sarbanes-Oxley Act of 2002.

Business people, regulatory organizations and investors have become acutely aware of irregularities in financial control management. The Sarbanes-Oxley Act supported by all but 3 members of Congress was passed in response to the breakdown in corporate checks and balances that cost investors hundreds of billions of dollars in losses.

For too long, too many companies have lacked adequate internal controls. In recent years more than a thousand public companies have issued corrections for errors in their financial statements. Auditors who used to test all the controls in which they were relying annually, cut back on the level of their tests significantly as they faced pressures to reduce their fees.

In the process of documenting their existing financial control environments which many had assumed were essentially complete, project managers have discovered a significant level of effort in the level of testing needed, the addressing of deficiencies discovered, and the documentation sufficient to support attestation by the auditors.

Other categories of compliance mandates could fall in a wide range of areas, including industry-specific (e.g. HIPPA), safety-related (OSHA), quality-related (ISO 9000, six sigma), global (NAFTA, WTO), or financial markets-related (NASDAQ, NYSE). They could be directed to customer support (service level agreements), banking (lending covenants), or supplier requirements (terms of purchasing agreements). Finally and perhaps more commonly, organizations will develop company-specific policies, procedures, and tasks which will incorporate the operating and cultural environment of the company and industry.

As if designing, implementing, running and evaluating the system were not enough, companies will need to identify factors and drivers of change to the financial control management system and quickly make and implement those changes on a regular and timely basis. A number of internal and external factors can drive the change. Internally, they include new corporate policies (in any functional area); the acquisition of a company or product line and major change in operational performance; and changes in personnel, documents or information. External factors that will drive changes to the financial control system include regulatory changes (e.g. new sections of federal law, new interpretations of accounting standards, tax law), competitive actions, supplier agreements, and lending institutions among others. Therefore, not only will establishing a comprehensive, systematic financial control system take time, training, and money, maintaining and sustaining it will require constant monitoring, evaluation, and maintenance.

The current problem with manuals of procedures is that there is no economically repeatable way to analyze the degree of compliance over time or across organizational entities. Nor is there a way to consistently score and evaluate how an organization is improving over time. There may not be objective measurements of the effectiveness of the control or tracking of remediation when controls are found ineffective. Nor is there enough information to make a business judgment on the urgency or importance of correcting an error or omission. A manual report on compliance to control binders cannot be automatically rerun to check if corrections have been effective.

### DISCLOSURE OF INVENTION

Summary of Invention

Accordingly, what is needed is an improved system of providing processes and automation to make compliance to new standards of internal control successful, economical, and verifiable. The present invention includes both apparatus and methods to automate both the efficient establishment of an complete and automated control system as well as ongoing, continuously measured and improved processes of ensuring appropriate internal control.

During the design and deployment phase which encompasses installation, configuration, and evaluation phases of deploying a system of controls, the present invention increases productivity by requiring lower skill levels for participation. A template-tized creation system allows non-programmers to develop systems of controls, evaluations, and tests for systems they are familiar with as users or financial professionals.

The underlying architecture uses twin hierarchies cross linked to each other as well as to lists of context data to provide efficiency, flexibility and to provide for better analysis of resulting transactional data. One hierarchy provides a framework to organize possibly thousands definitions of financial controls and their associated evaluations and tests. The other hierarchy provides a framework to describe an enterprise or organizational structure ultimately to the level at which user roles to be associated with the design and operation of financial controls can be automated.

Each member of the definition hierarchy has a data element specifying its frequency of application and a relationship to the framework recommended by industry reporting standards bodies. The use of templates for the definitions simplifies the development and maximizes reuse. The other hierarchy reflects the responsibility of performing controls, evaluations, and tests as well as providing for the assignment of escalation or follow up roles. Personnel or performers in an enterprise are organized into a hierarchy of units which may be geographical, functional, market, historical or any mixture of legacy organizational structures. Linking of higher level nodes in the twin hierarchies allow for more efficient assignment of one or more controls to many units and vice versa.

The present invention enables the rapid integration with legacy systems by use of templates which drive existing backend applications to present integrated user interfaces. In contrast to previous approaches which either emphasize the automation of creating documentation or the self documenting nature of writing software, the present invention enables without the need for programming skills the definition of a self-executing internal control system by means of preparing the documentation of the internal controls and the assignment of performers. The nature of the definitions prepared for the internal control hierarchy encompass the control itself, its method of being evaluated, as well as a set of tests of the control. As a result of having the controls related in a hierarchy according to the objectives and risks prioritized by the entity, management can review the evaluations and tests in preparation for its assertion of compliance and external audit organizations can review the hierarchy of definitions and their test results as support for their attestation of complete compliance.

In the production and continuous improvement phase of the present invention, the present invention coordinates the timely delivery of information to performers responsible for performing elements of the internal control system. Every control is defined with a type of frequency according to its relevant financial period and is automatically scheduled with appropriate lead time prior to the due date. Each assigned performer receives a customized email with a url to obtain detailed directions, data, and the on-line resources needed for that activity. A process template delivered to the user's client workstation is populated by the selected process template data defined during the design/deployment phase and his submitted results recorded. The Application Container offloads formatting and interactivity to the client browser at the user's desktop and assembles the routed data and provides a mini-application. Parameters in each control allow reminders or escalation steps to occur in a timely manner according to action or even non-action thereby losing no transaction.

In short, to assure regulators, stockholders, tax-payers, customers, and suppliers to large public and private entities that proper and thorough internal control have been established and are respected, new standards of responsibility, behavior, and measurement have come into use. The present invention makes it possible not only to economically comply with these new reporting requirements but also leverage these investments to contribute to the day-to-day efficient operation of the entity in its main business processes by addressing risks to attaining its objectives.

### BRIEF DESCRIPTION OF DRAWINGS

FIG. 1. System Architecture and Process Overview

FIG. 2. Control Hierarchy and Context Data Structure

FIGS. 3a and 3b Units and Sub-Unit List Data Sample and Detail Sample

FIG. 4. Creation of Definitions Flow Chart

FIG. 5a-d Internal Control Definition Sample

FIG. 6. Scheduler Flow Chart

FIG. 7. Environmental Infrastructure Architecture

FIG. 8 Application Container with Sample Data

FIG. 9 Routing Engine Flow Chart

FIG. 10 Configuration & Initialization Flow Chart

FIG. 11 Hierarchical Definition Flow Chart

FIG. 12 Compliance Rules User Selection Screen

### BRIEF DESCRIPTION OF THE DRAWINGS

Detailed Description While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

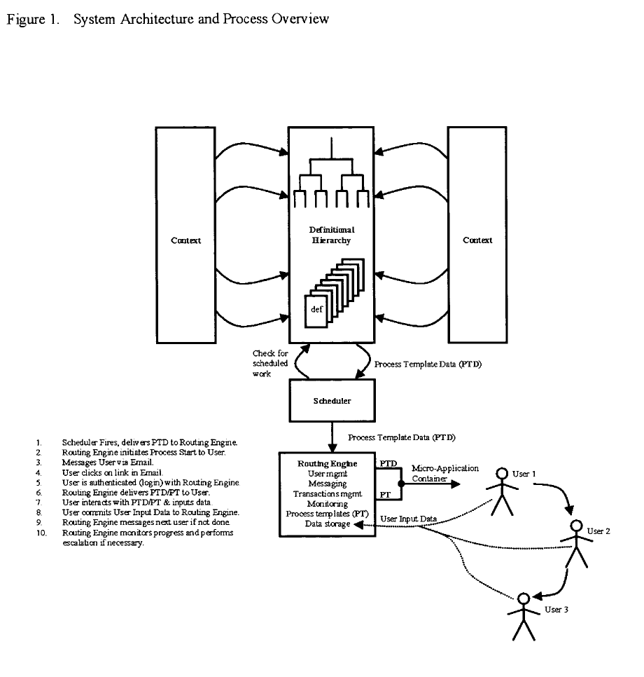

Referring now to FIG. 1, System Architecture and Process Overview, the present invention comprises a definitional hierarchy structure, coupled to a plurality of context structures, and coupled to a scheduler by means of process template data, which scheduler is further coupled to a routing engine by means of process template data, which routing engine dynamically synthesizes, transmits, and reads micro application containers presented to and submitted by a plurality of users as uniquely directed by the process template data of each definition. As each definition is found within a hierarchy with its required frequency and start and due latency requirement, the scheduler may traverse the definition hierarchy and deliver the selected process template data to the routing engine. The process template data includes the responsible unit or performer by linking the unit structure found within the context data so that the routing engine may notify a plurality of users by email. By clicking on a url within the email or otherwise connecting to the routing engine, the user, after authentication, accesses the process template data as presented by the routing engine within the appropriate process template. The user reads data and instructions, may optionally run mini-applications, and otherwise interacts with the process template and the process template data, with the expectation of closing the loop by submitting data or performing actions. In the absence of completion of the control activity observed by the scheduler within a proscribed time, the scheduler will monitor progress and message an alternate user, or escalate if necessary, recording the variance from expected performance for measurement.

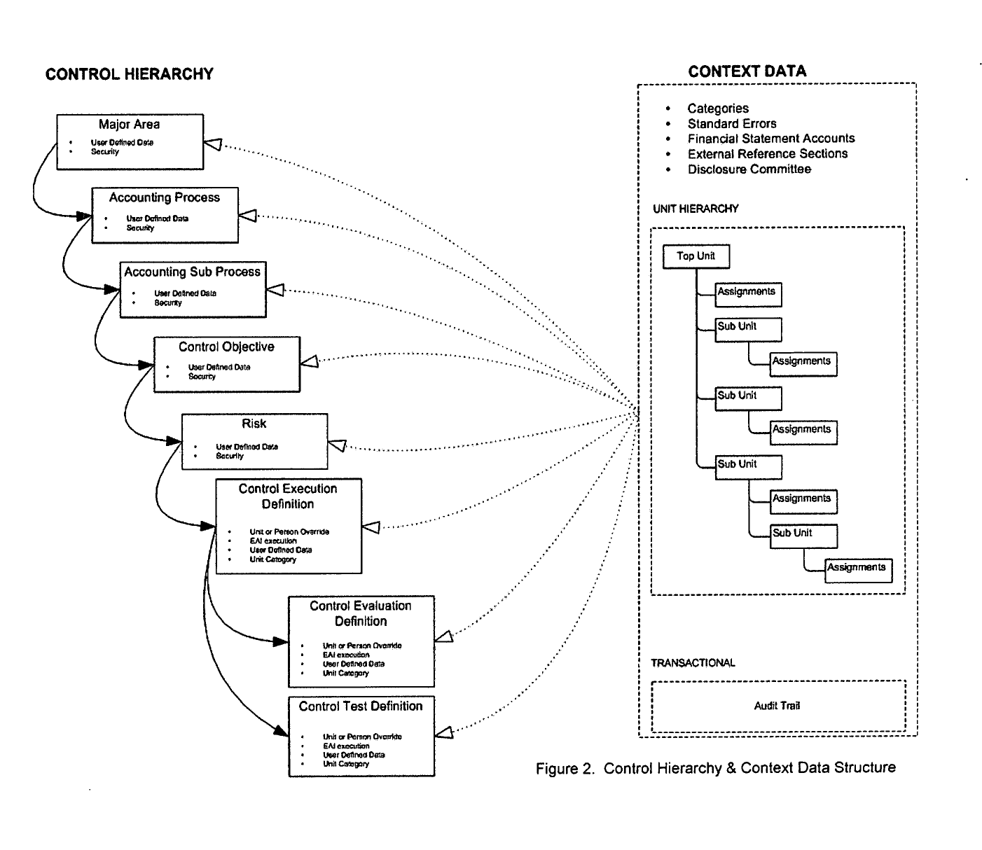

Referring now in detail to FIG. 2 Control Hierarchy and Context Data Structure, a computer readable medium is disclosed which controls the operation of the invention by having encoded upon it a control hierarchy structure including a plurality of Major Areas each of which may have encoded upon the computer readable medium a reference to a plurality of Accounting Processes each of which may have encoded upon the computer readable medium a reference to Account Sub-Processes each of which may have encoded upon the computer readable medium a reference to Control Objectives each of which may have encoded upon the computer readable medium a reference to Risks each of which may have encoded upon the computer readable medium a reference to Control Execution Definition each of which may have encoded upon the computer readable medium a reference to a Control Evaluation Definition and to a Control Test Definition.

Each member of the Control Hierarchy Structure named above may have encoded upon the computer readable medium a reference to an element of a repository disclosed as Context Data also encoded upon a computer readable medium to control the operation of the invention. Each Control which may be executed, evaluated, or tested has a default or specified performer assigned from the members of the Unit Hierarchy element of Context Data.

Within the Context Data is shown the Unit Hierarchy of users responsible for creating, performing, evaluating, or testing the Controls. Their responsibility may be assigned individually or by means of the hierarchy. Any level of the Control Hierarchy may be assigned to an individual in the Unit Hierarchy who shall be the default performer of every control below that level of Control. These defaults may be overridden by further assignment by category or by specific assignment to an element lower in that Control Hierarchy. Failure or delay of an assigned individual to perform a control in a timely manner automatically invokes an escalation procedure by the scheduler which will contact the person designated in the Unit Hierarchy. Thus it will be observed that the Unit Hierarchy may be distinguished from a traditional table of organization because the knowhow and appreciation of performing controls will frequently not correspond to the chain of command authority.

Also with the repository of Context Data is information useful to users which may be referenced by the Controls but is not embedded in each control for efficiency. The business logic behind each control, use of standard language in creating or modifying controls, identification of regulatory or audit requirements that are pertinent to the controls and their ranges of acceptability are all centralized in the context data structure.

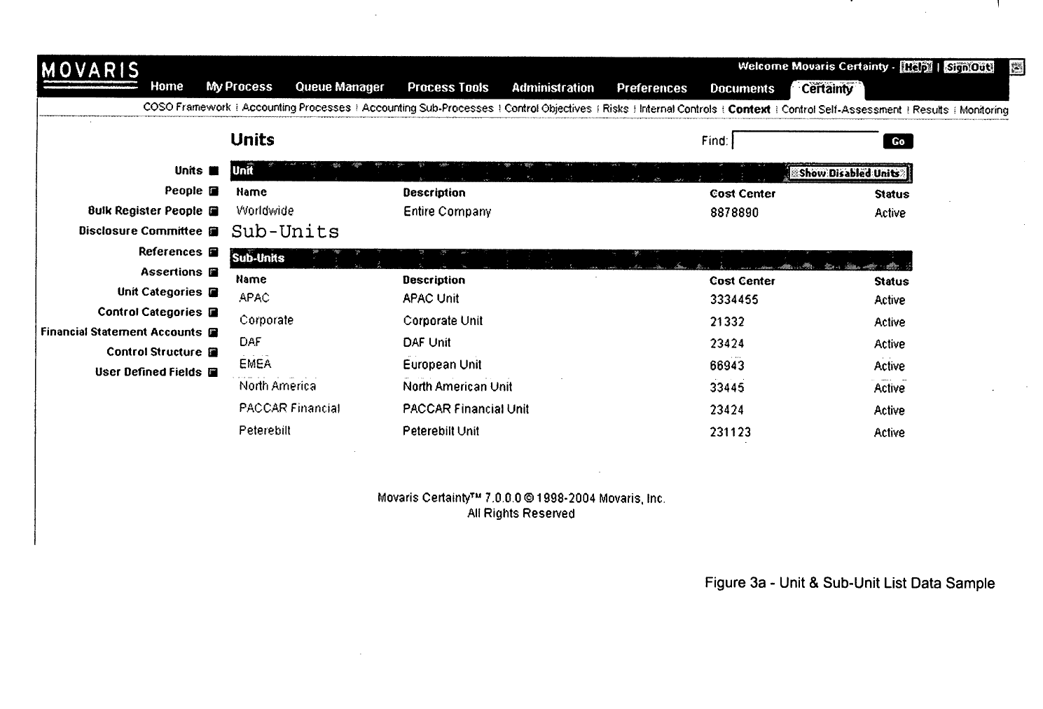

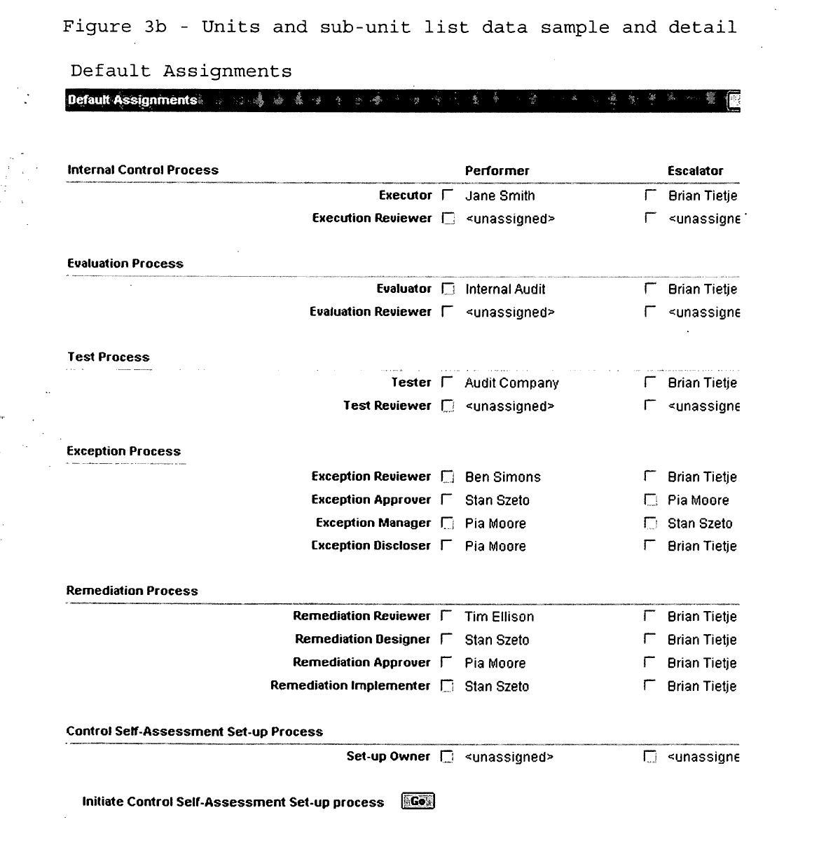

Referring now to FIGS. 3a, and 3b Units and Sub-Unit List Data Sample and Detail Sample, the present invention discloses a hierarchy of units and sub units. Units and subunits may be further comprised of subunits or a plurality of persons who have either broad authority or assigned roles. Different persons may be assigned the performance, evaluation, and testing of a control or in the event of non-performance be one to whom the issue is escalated.

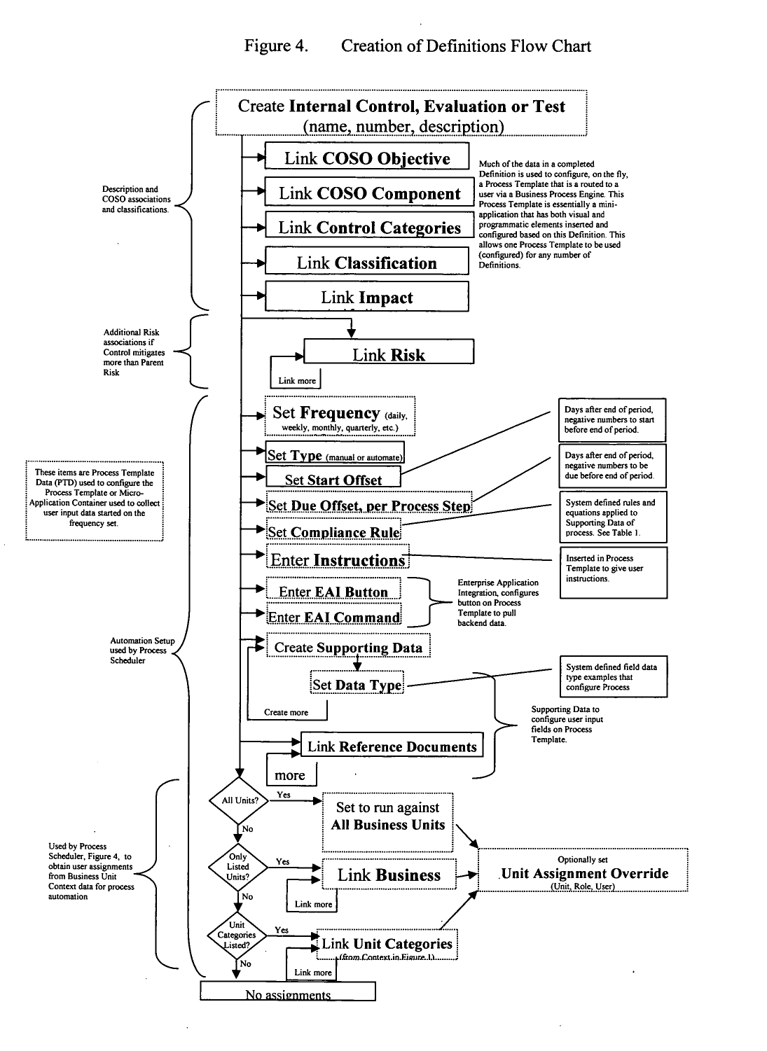

Referring in detail to FIG. 4. Creation of Definitions Flow Chart, a definition is firstly described and linked to a COSO objective, COSO component, control category, classification, and impact. Each definition may be linked to a plurality of risks. Secondly, data is collected to configure a process template or micro application container used to collect user input data started on the frequency set. The following data related to a process template: a frequency, a due offset, a compliance rule, instruction text, EAI button text, EAI command xml text, a plurality of supporting data fields with optional error checking data types is used to configure on the fly, a process template that is routed to a user via a business process engine. This process template is essentially a mini-application that has both visual and programmatic elements inserted and configured based on this definition. An advantage of the present invention over previous conventional applications is that one process template may be used for any number of definitions. Optionally, each control may be linked to a plurality of reference documents which help the various users or analysts understand the control and document its significance.

The final steps control the operation of a computer system by specifying if the scheduler shall notify all units defined in the unit structure, a plurality of units by linking to a list of Units, or a plurality of unit categories by linking to unit categories or not assigning controls to any units for automatic scheduling. In each case, it is possible to set specific overrides to default assignments to deal with unique and exceptional situations. In contrast to other implementations of controls, the definition of the control documents both the frequency of being run and the performer who must participate.

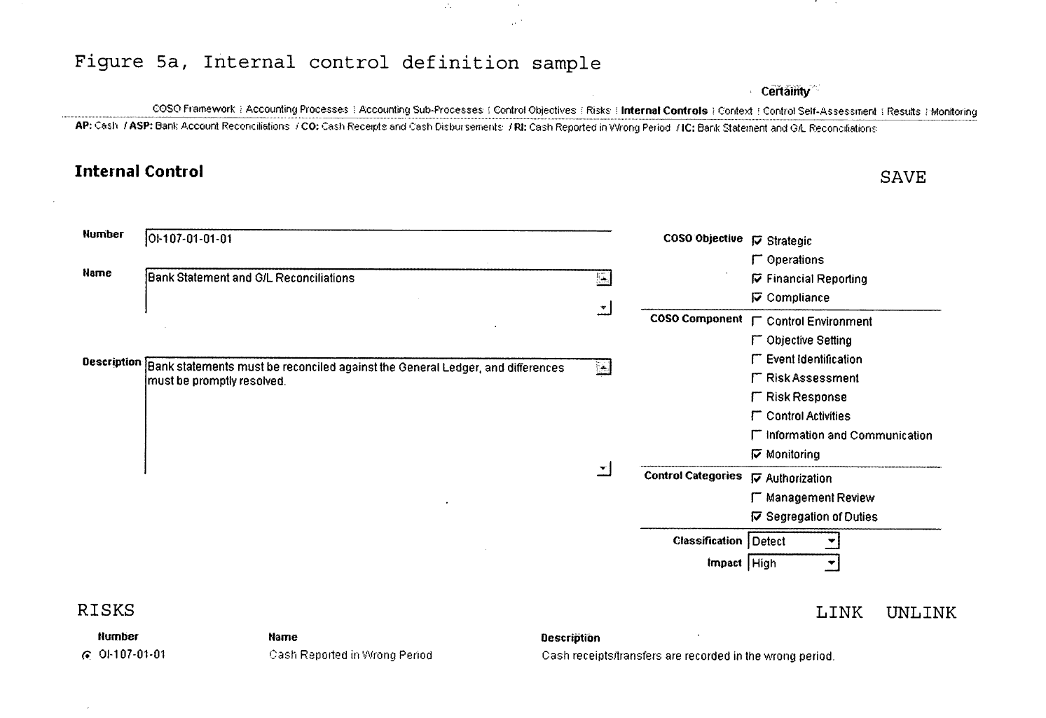

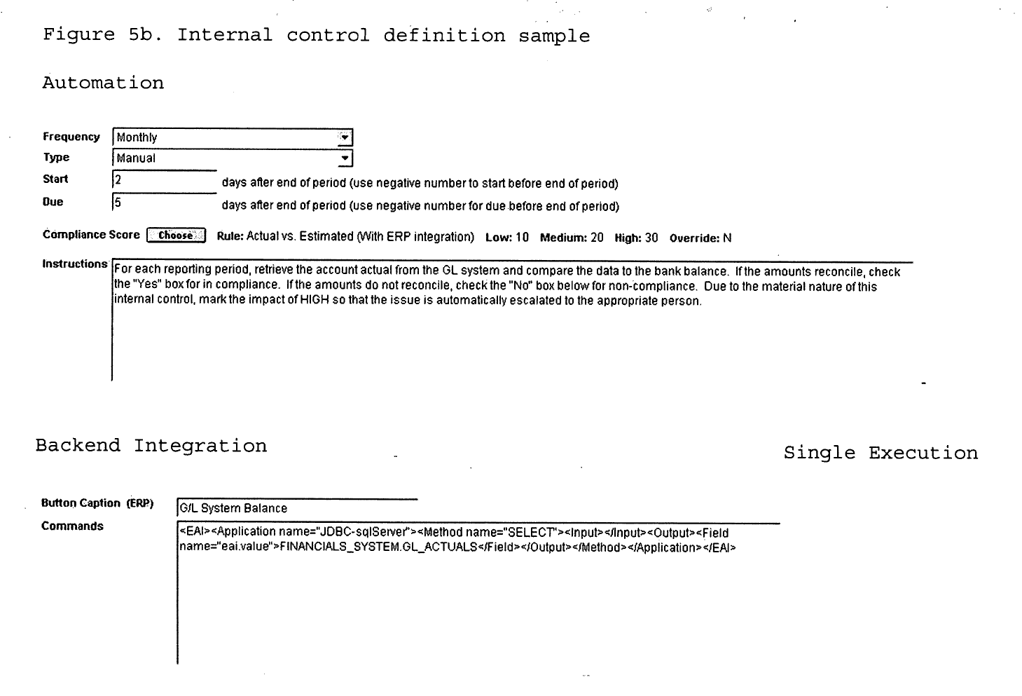

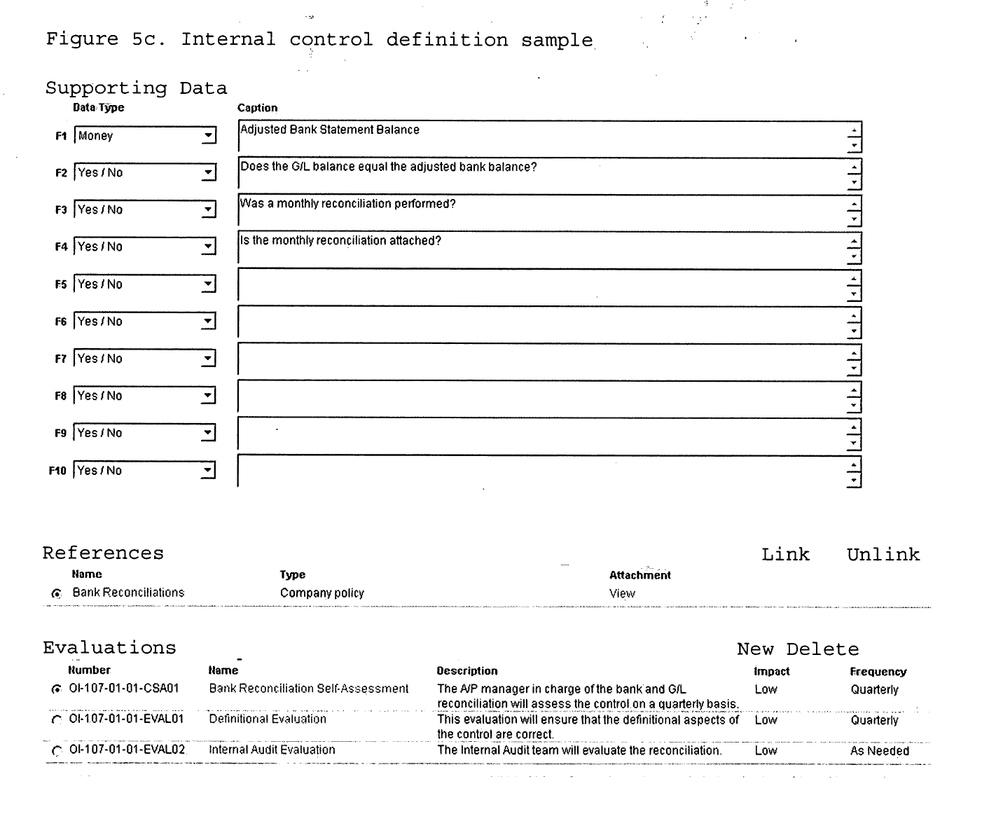

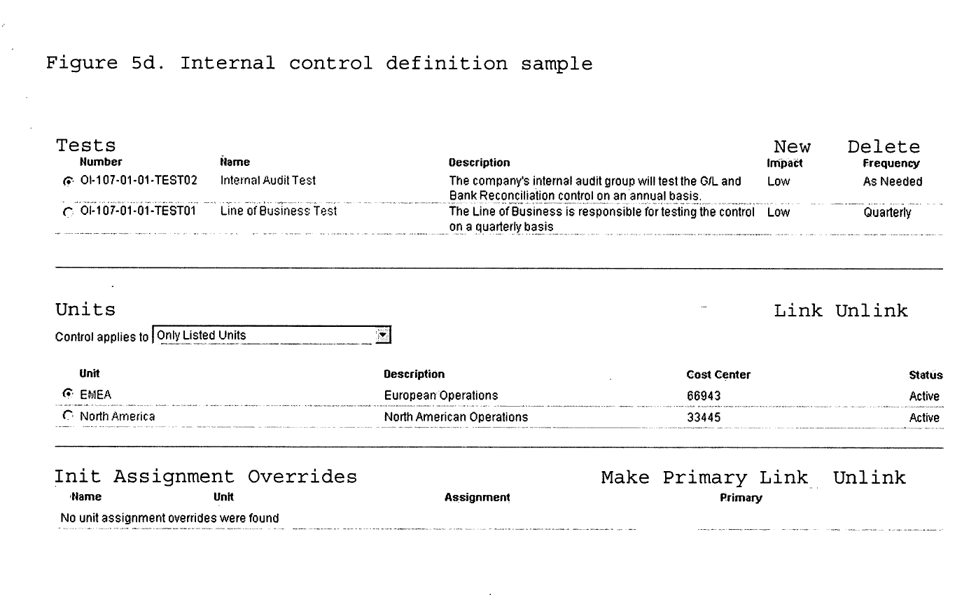

Referring now to FIGS. 5a-d Internal Control Definition Sample, each internal control may be associated with a plurality of COSO objectives, Components, and Risks. Optionally they may be placed in a control category for ease of selection. They must have a classification and a assessment of impact on the overall entity. Internal control is defined for automation purposes as having a frequency with a window for start and due dates. In the preferred embodiment, instructions to the user are incorporated into the control with optional ability to start a backend ERP application data pull by hitting a user-defined button. Various data fields may be defined for input or display with optional checking for legitimate data type on input fields. A control may have links to references for further clarification. Each control will have a plurality of evaluations, tests, and assigned units. A specific control within a hierarchy may have a unit assignment override that differs from the assignment that the rest of the hierarchical branch is assigned.

Referring now in detail to FIG. 5a Control Definition Screen Part 1 the present invention creates an internal control definition with a name and description that is linked to a plurality of Objectives, Components, Categories, and Risks with a classification and an impact.

Referring now in detail to FIG. 5b Control Definition Screen Part 2 each internal control must be set up for automation by the Process Scheduler by having a value for frequency and Type of process and a start and due value relative to the end of the financial period. Each control has an effect on the overall compliance score. Specific instructions are included in the notification to the assigned performer in an action document. The document may include operable buttons that execute backend ERP commands which are specified on this screen.

Referring now in detail to FIG. 5c Control Definition Screen Part 3 each internal control may be defined with input fields that have data type checking and captions. It may have references attached for further documentation of its purpose and consequences. Each control must specify a method of evaluation and its frequency which is selectable from standard methods using this screen.

Referring now to FIG. 5d Control Definition Screen Part 4, each control has a test associated with it and is assigned to a unit. Within a hierarchical group of controls assigned to a unit, an individual control may be assigned to a specific unit overriding the hierarchically inherited assignments.

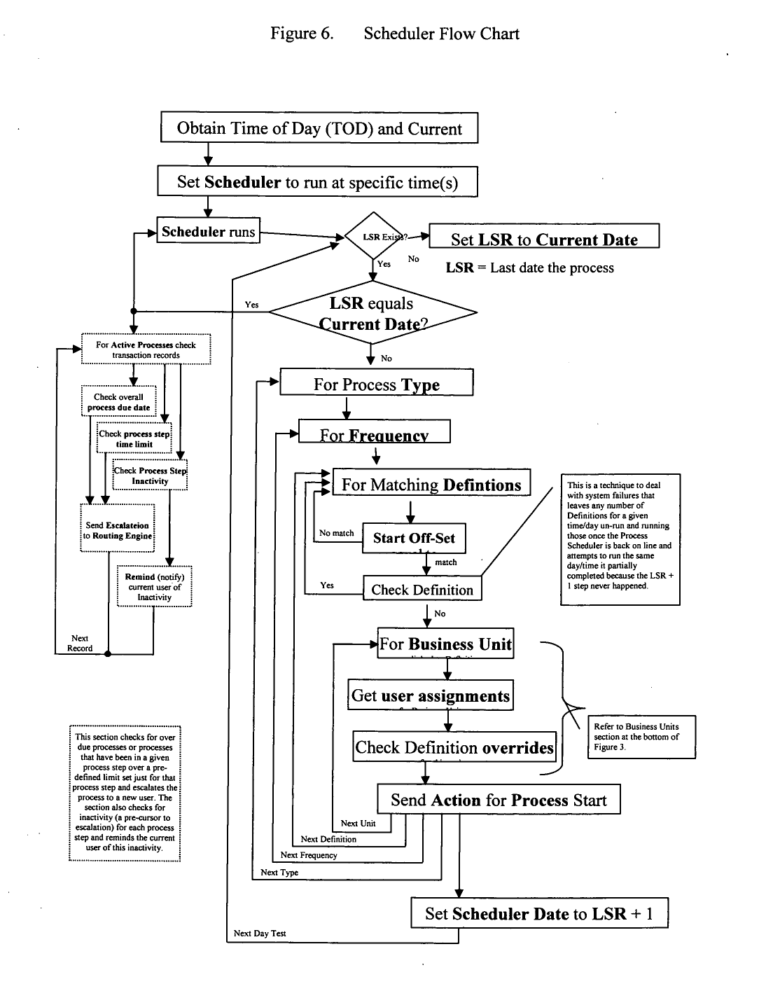

Referring now to FIG. 6, Scheduler Flow Chart, during system initialization the Process Scheduler is started manually and records the last time it successfully completes its run (LSR). The computer system itself monitors the time of day and current date and periodically starts the Process Scheduler at one or more specific times each day. The process scheduler comprises the following steps: comparing the current day and time of day against the Last Successful Run to determine if it is necessary to schedule processes, selecting one of a plurality of process types selected from the group consisting of controls, evaluations, and tests, selecting one of a plurality of frequencies selected from the group consisting of hourly, daily, weekly, monthly, quarterly, annually, matching definitions against the selected process type and frequency, computing the start offset for each definition and comparing to the Current Scheduler Date, comparing the Last Successful Run date for each definition against the Current Scheduler Date, identifying the Business Unit(s) linked to each selected definition directly or by means of Context Data Category lists, reading the default user assignment for each Business Unit, checking if the Definition overrides this specific assignment, and causing the Routing Engine to route the Process to the assigned user, proceeding in turn to the next unit identified in the definition until all are processed, proceeding in turn to the next definition until all are processed, proceeding in turn to the next frequency until all are processed, proceeding in turn to the next type until all are processed and setting the scheduler Date to the Last Successful Run date plus one increment, in the figure shown as one day. This allows the scheduler to deal with a partial or multi-day outage which has interrupted the normal operation of the schedule and eliminates the possibility that processes are skipped on days that the Scheduler failed to complete or was prevented from running at all. Similarly, the Scheduler checks for Active Processes that have been initiated by the Routing Engine and may send a reminder to the assigned performer or cause the routing engine to pass this transaction on to an alternate performer or to escalate to a higher level of responsibility. This section checks for overdue processes or processes that have been in a given process step over a predefined limit set just for that process step and escalates the process to a new user. The section also checks for inactivity (a pre-cursor to escalation) for each process step and reminds the current user of this activity. The advantage of the present invention over the previous art of scheduling is to enable the system, in the event that a Data Center has an extended and unscheduled outage for several days, to automatically catch-up without user intervention by causing itself to repeat for all the missed scheduler executions once the Data Center returns on-line.

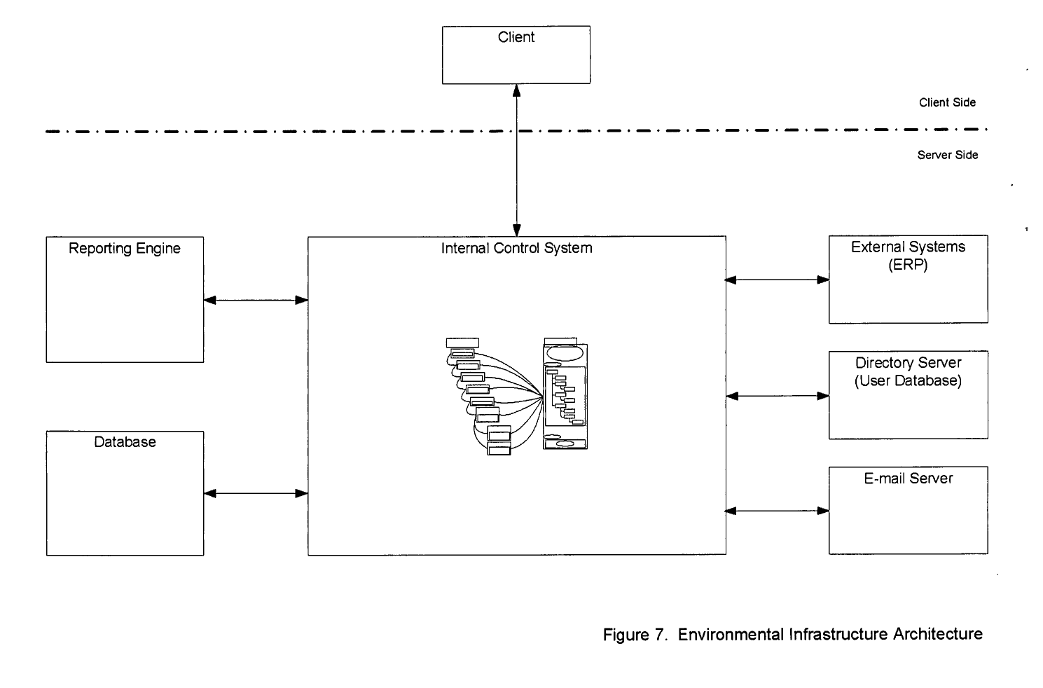

Referring now to FIG. 7, Environmental Infrastructure Architecture, the disclosed invention is shown as a practical and economical Internal Control System with a plurality of standard interfaces to well understood but poorly integrated applications known in business enterprises. Beginning at the top and turning clockwise, we show that display to and receiving input from clients in the user environment provides both the definition of controls and the performance, evaluation, and test of these controls. The next interface clockwise shows the integration through well known programmatic interfaces to external applications known as enterprise resource planning containing information on sales and financial reporting. Below that is shown the interface to a Directory Server used for authentication of the users who are responsible for creating, performing, and taking responsibility for the accuracy of the controls. In the lower right is shown an interface to any legacy E-mail Server, through which the Internal Control System will notify performers of upcoming Control actions as well as reminders and escalation to supervisors if actions have not been taken or the results require an exception to be alerted. Proceeding in a clockwise manner to the lower left is shown the Internal Control System interface to any of a number of standard computer database products which manage underlying resources through instructions according to the methods of the present invention. Finally next above is shown an interface to a reporting engine, which is used by the present invention to format according to the preferences of the users the reports charts and displays used to manage, document, and attest to the controls herein implemented. The present invention is a more practical and easily deployed application by utilizing information and resources already present in business enterprises and adding automation to the business process of internal controls.

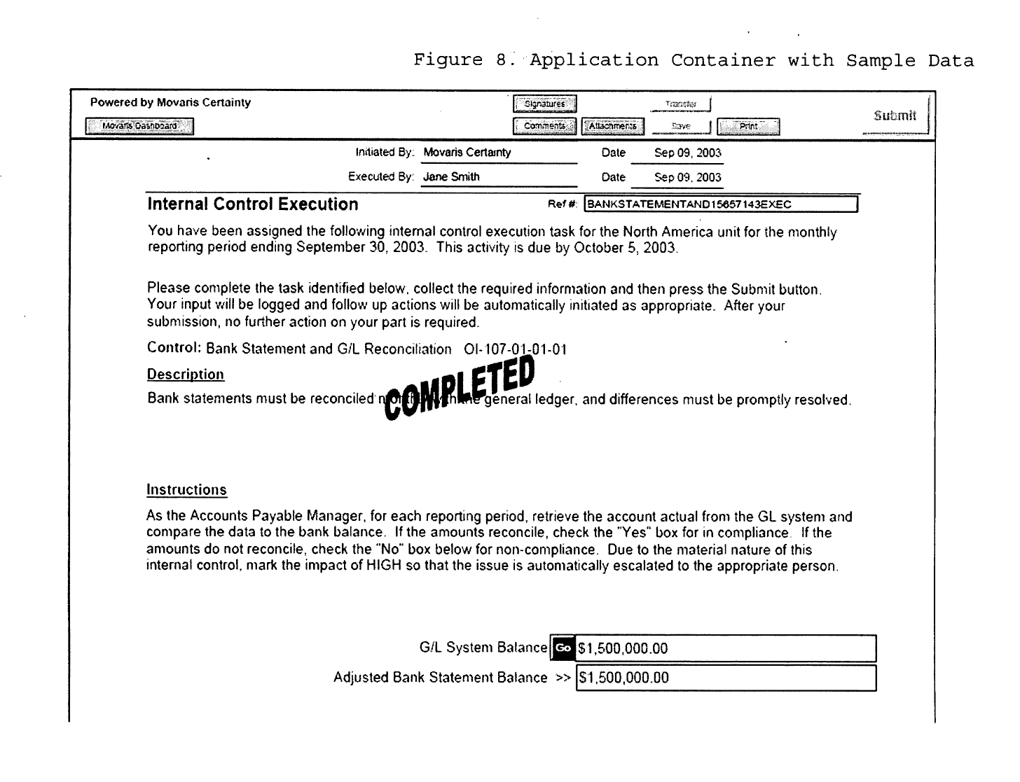

Referring now to FIG. 8 Application Container with Sample Data, what is shown is the result after a user has been notified and clicks on a url and has been authenticated, the process template and process template data defined in FIGS. 5a-d combined through the application container template method of controlling the operation of a computer system to deliver unique documents for action to the performers assigned to each scheduled control, evaluation, test, or other function.

In this example the performer is instructed to execute a query on the General Ledger system and manually enter the corresponding value from their bank and record if the amounts reconcile. In this example the document is marked as a completed control for the record. Note that various buttons are selectively displayed or rendered inoperable according to the status of the control. The present invention controls the operation of the computer system in scheduling the preparation of this document, determining the buttons and fields shown on the document, determining the text content of the document, transmitting the document to the assigned performer and monitoring performance, escalating the document if performance does not occur in a timely manner, and scoring the compliance and recording out of compliance results thereby automating an internal financial control system.

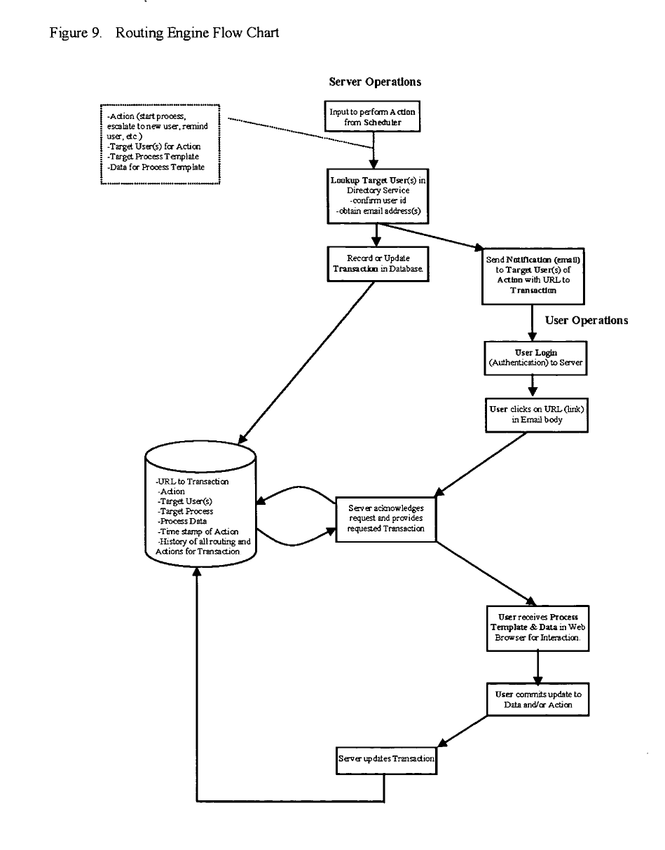

Referring in detail to FIG. 9, Routing Engine Flow Chart under the control of the present invention, the computer system operates by first scheduling a definition such as the internal control execution task shown, identifying a performer assigned and transferring the process to the Routing Engine comprising the steps of firstly Looking up the target unit and authenticating them using a directory service thereby obtaining an email address and secondly recording or updating a transaction in a database while sending notification to the target with a url link to the transaction in the database and thirdly waiting until the user clicks on the url to assemble a micro application container by pulling together elements specified by the Control Definition Screens parts 1 through 4, and transmitting it electronically to the users client as a process template and accompanying process template data for interaction and acknowledging subsequent submittal and recording submitted data. Processes are sent to the Routing Engine by the Scheduler according to the start date and if no response received by the due date, the Scheduler initiates a new process for the Routing Engine escalating the control to the performer specified in the unit.

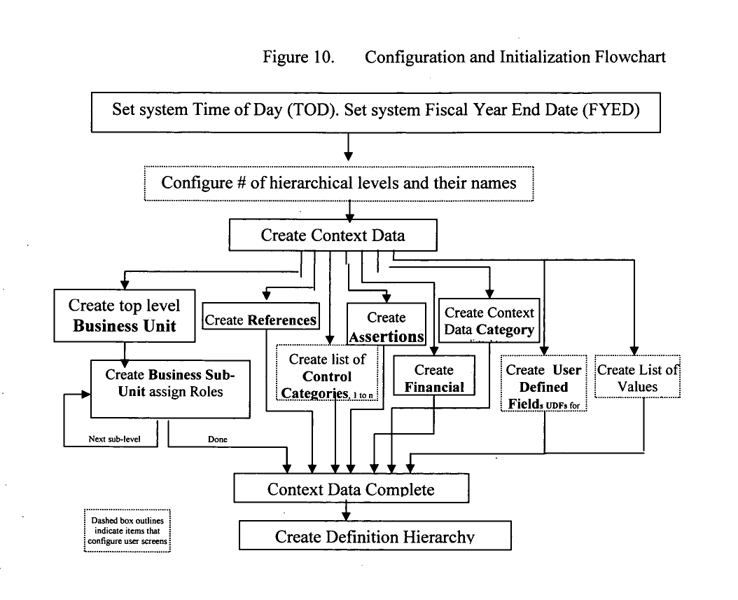

Referring in detail to FIG. 10 Configuration & Initialization Flow Chart, the present invention, causing a computer system to change its operation according to the controls embodied on computer readable media, begins with the step of setting the system Time of Day and the system Fiscal Year End Date which may be specific for each entity or enterprise. The next step is to configure the number of hierarchical levels in the control structure and to specify the name of each hierarchical level. This sets up what levels the system will allow to be created above definitions of Controls, Evaluations, and Test. This allows a financial organization to apply their particular cultural naming in lieu of the standards body naming conventions such as Accounting Process, Accounting Sub-Process, Control Objective, and Risk. The next process is that of creating Context Data which comprises a plurality of steps including but not limited to the following: Creating and populating a list of Context Data Categories, Creating a list of Financial Statement Accounts, Creating a list of Assertions, Creating a list of Reference Documents, Creating if desired a List of Values, Creating if desired a list of User Defined Fields to allow extensibility and customization, Creating if desired a list of Control Categories, and Creating a Unit Structure for the purpose of assigning users Roles for controls and associated tasks comprising the steps of Creating a top level Unit and then Creating a plurality of Sub-Units until all users who have Roles for controls and associated tasks have been assigned. The steps shown within dotted line boxes indicate methods that change the operation of the computer system by displaying different screens to the users according to the context data herein configured. After the Completion of Configuration of the hierarchy and the Context Data, the next step consists of Creating the Definition Hierarchy wherein the present invention changes the operation of the computer system according to said step of configuring the number of hierarchical levels and their names.

Only two levels of hierarchy are mandatory, the Control and the Control evaluation. At installation, the other levels may be deselected for a simpler implementation. They will be hidden from the user post-installation. There may be multiple Major Areas or not as may be the case. For each Major Area there may be a plurality of Accounting Processes. For each Accounting Process there may be a plurality of Accounting Sub-Processes. For each Accounting Sub-Process there may be a plurality of Objectives. For each Objective, there may be a plurality of Risks. For each Risk, there may be a plurality of Controls. The heart of the system are the Controls and Control Evaluations. The hierarchy above them is for clarity of organization and convenience of assignment. Controls and Control Evaluations are paired. Each Control may have a plurality of Tests. The list of Abbreviations is shown when any specific control is being displayed as a hierarchical path to locate the control within the hierarchy.

Note also the control self-assessment setting. If the Use Control Self Assessment radio button was set to No, the related selection would be not shown or in gray. If Yes, then the installer may select from available Self Assessment levels and set the frequency that the organization wishes to perform self-assessment. Finally an optional rollup of the self-assessments is offered and in this case denied.

The degree of detail for management's assertion of control efficacy is selectable and the appropriate documentation for the auditor's attestation is automatically created to support the assertion and attestation.

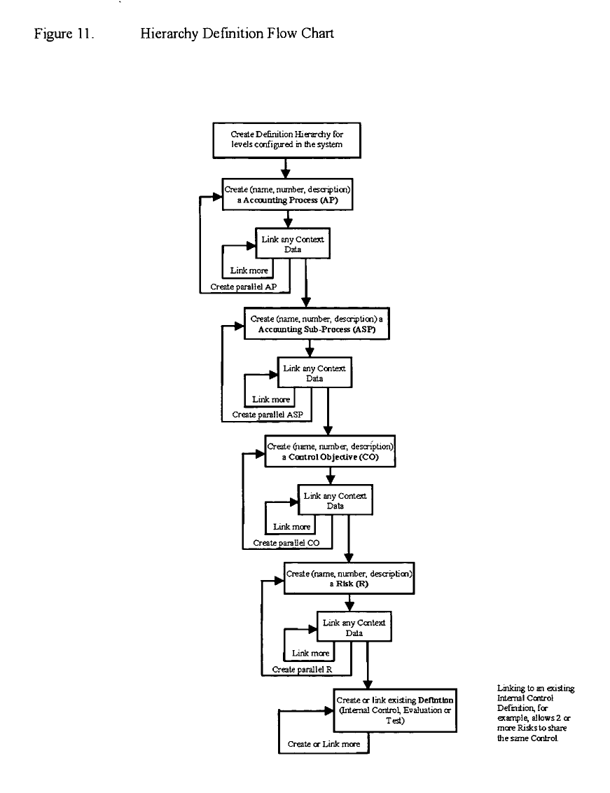

Referring now to FIG. 11 Hierarchy Definition Flow Chart, a method of creating a Definition Hierarchy for levels configured in the System Configuration which control the operation of a computer system comprise the steps of Creating a plurality of Accounting Processes and linking each Accounting Process to a plurality of Context Data, Creating a plurality of Accounting Sub-Processes and linking each Accounting Sub-Process to a plurality of Context Data, Creating a plurality of Control Objectives and linking each Control Objective to a plurality of Context Data, Creating a plurality of Risks and linking each to a plurality of Context Data, and Creating a plurality of Definitions or linking to a plurality of existing Definitions of Internal Controls, Evaluations or Tests. Linking to an existing Internal Control Definition, for example, allows 2 or more Risks to share the same Control.

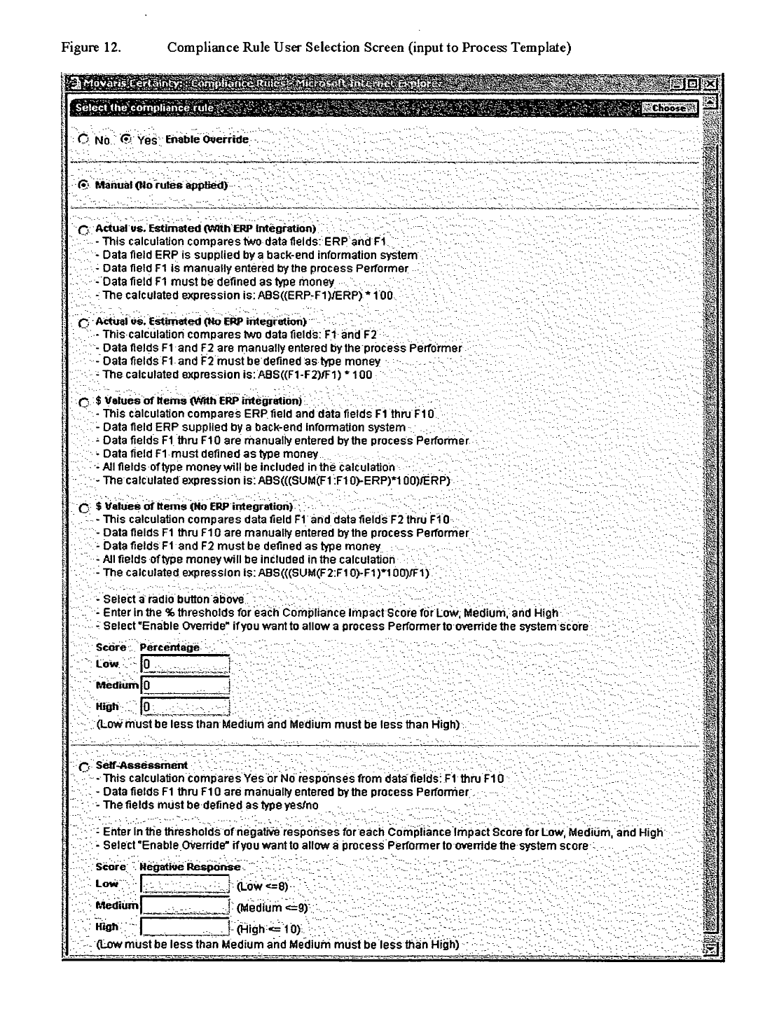

Referring now to FIG. 12 Compliance Rules User Selection Screen, the present invention enables insertion of programmatic elements into a Process Template to act upon supplied Supporting Data supplied by user at run time, a plurality of radio buttons are offered as mutually exclusive selections to illustrate user selection of typical calculations. The performer may enter in actual and estimated values for a specific calculation or enter in one value and pull data from a back-end ERP application. The performer may enter a sequence of values for a complex calculation or do that in combination with data pulled from an ERP application. The result can be categorized automatically as being below or above a threshold of acceptable ranges for compliance impact. This documents and consistently applies criteria for identifying financial measures that are significantly out of compliance with corporate objectives eliminating variation in judgment or omission of calculations. Periodically, financial controls must be evaluated by the performers themselves as to their continued accuracy and pertinence. This screen also shows how to accumulate and categorize self-assessments to achieve an overall score for reporting and planning remediations. What is being illustrated here is that for each Internal Control, Evaluation, or Test, the creator may select from and reuse available calculations, scoring, or thresholding techniques without recreating or reinstantiating custom code thereby increasing productivity and reducing opportunities for error.

### BEST MODE FOR CARRYING OUT THE INVENTION

Preferred embodiment In the preferred embodiment of the present invention everything
Is entirely data driven
No user programming is required
Natively integrates with intranets and email
Contains built-in, two-way integration with ERP, CRM, HR, and legacy enterprise applications
Runs in Windows and UNIX environments
Works with industry-standard application servers and databases from IBM, BEA, Oracle, and Microsoft

Because it is based on a production-proven, scalable business process management platform, it proactively monitors and manages all the reminders and follow-up needed across an entire organization to ensure that internal control activities are completed correctly and on time. It is designed specifically for Sarbanes-Oxley control documentation and ongoing monitoring.

In contrast with systems of previous design,
The present invention is a comprehensive corporate control management solution that includes all three phases of compliance: control definition and documentation; ongoing control monitoring; and cost-minimizing attestation preparation and reporting
The present invention is an application designed specifically for Sarbanes-Oxley, and not a generic tool that requires extensive customization and consulting.
The present invention is built on a production-proven business process management (BPM) foundation to ensure quick adaptability to change.
The present invention is more than a simple document repository. It also stores control activity information in a database to create detailed audit trails, reports and analyses.
The present invention generates the evidence an independent auditor needs to issue an unqualified attestation report.
The present invention enables users to manage and monitor a comprehensive set of internal controls on an ongoing basis rather than simply scheduling audits.
The present invention is a full compliance management application that enables users to author, document, monitor, test, remediate and report on internal controls rather than an authoring tool.
The present invention is an application that integrates with all ERP systems and instances, rather than being an ERP vendor's proprietary internal control tool that can't span other back-end systems.
The present invention is a continuously monitored risk profile of an organization rather than a one time risk assessment utility.

Control Definition The present invention provides a straightforward, structured method for defining internal controls.
Provides a formal framework for defining accounting processes, sub-processes, control objectives, risks, and controls across the organization
Ties controls to proper context: the COSO framework, company policies, SEC and PCAOB rules, auditor advice, and legal opinions
Assigns responsibility and execution process to each control Imports control definitions from accounting firm tools

Control Execution The present invention ensures that each and every control is executed on time, correctly, and completely while providing full visibility into the process.
Ensures on-time execution of controls through a proactive process of notification, follow-up, and escalation
Delivers details of each control including instructions and context to each user ensuring that each control is executed completely and correctly
Offers full visibility during the execution process so that management can take corrective action before it's too late
Provides full audit trail including control execution results and signoffs
Captures all supporting documentation in any format for each control execution
Integrates data from ERP systems directly into the Movaris Certainty process easing the compliance task and ensuring accurate and timely execution

Annual Control Evaluation The present invention enables management to meet its evaluation obligation under the Sarbanes-Oxley. It drives the annual control evaluation process while offering full visibility into the status and results of the ongoing process.
Provides a systematic framework for defining, scheduling, and conducting the evaluations to be performed for each control
Defines the criteria against which the control will be evaluated and specifies the responsibility path and process for each evaluation
Ensures on-time execution of all evaluations through the designated process of notification, follow-up, and escalation
Provides real-time visibility into the status of all evaluations across the organization, by specific control or division

The foregoing description of the embodiments of the invention are to be considered in all respects as illustrative and not restrictive, the scope of the invention being indicated by the appended claims rather than by the foregoing description, and all changes that come within the meaning and range of equivalency of the claims therefore are intended to be embraced therein. The embodiment described is selected to best explain the principles of the invention and its practical application to thereby enable others skilled in the art to best utilize the invention in various embodiments and with various modifications as suited to the particular purpose contemplated. In particular, Applicants contemplate that functional implementation of invention described herein may be implemented equivalently in hardware, software, firmware, and/or other available functional components or building blocks. Other variations and embodiments are possible in light of the above teachings, and it is thus intended that the scope of the invention not be limited by this Detailed Description, but rather by claims following.

1. A computer system for documenting, performing, and attesting to internal controls of a public or private entity or enterprise comprising: a processing server unit, a plurality of client workstation units, a communications network, and a computer-readable storage medium encoded with a computer program product which modifies the operation of said computer system by first scheduling by means of a scheduler the processing of a selected list of business control definitions, second notifying selected performers in a unit structure of their required activity within a time period by means of an email system, third routing the necessary process template and process template data comprising information, instructions, buttons, applications, fields, and references deemed useful for the defined activity by means of a routing engine, fourth, recording the performer's submittal of the business control activity by operating on the process template and process template data by means of a database, and fifth, preparing the supporting materials for officers of the corporation to assert and external auditors to attest that adequate financial controls meet regulatory requirements wherein, scheduling the processing of a selected list of business control definitions is done by a scheduler directing the operation of the computer system as follows: comparing the current scheduler day and time of day against the last successful run to determine if it is necessary to schedule processes, selecting one of a plurality of process types from a group consisting of controls, evaluations, and tests, selecting one of a plurality of frequencies from the group consisting of hourly, daily, weekly, monthly, quarterly, and annually, matching definitions against the selected process type and frequency, computing the start offset for each definition and comparing to the current scheduler date, comparing the last successful run date for each definition against the current scheduler date, identifying the business unit linked to each selected definition, reading the default user assignment for each business unit, checking if the definition overrides this specific assignment, and routing the process to the assigned user, proceeding in turn to the next unit identified in the definition until all are processed, proceeding in turn to the next definition until all are processed, proceeding in turn to the next frequency until all are processed, proceeding in turn to the next type until all are processed, and setting the scheduler date to the last successful run date plus one increment and reiterating until the current scheduler date exceeds the computer system current date.

2. The computer software program product of claim 1 wherein a definitional hierarchy structure is coupled to a plurality of context structures and to a plurality of context data category lists, and is coupled to said scheduler by means of process template data, which scheduler is further coupled to a routing engine by means of process template data, which routing engine dynamically synthesizes, transmits, and reads micro application containers presented to and submitted by a plurality of users as uniquely directed by the process template data of each definition.

3. The context data category of claim 2 comprising further lists of context data categories or lists of context data structures wherein said context data category associates disparate context items that may or may not be related by context type or by their location in a hierarchy but which may be efficiently linked to either the definitional or unit hierarchies by a single assignment from any level of the respective hierarchies to the context data category comprising the appropriate references, units, values, standard errors, assertions and any member of the set of context data.

4. The definitional hierarchy structure of claim 2 comprising a control hierarchy structure including a plurality of major areas each of which may have encoded upon the computer readable medium a reference to a plurality of accounting processes each of which may have encoded upon the computer readable medium a reference to account sub-processes each of which may have encoded upon the computer readable medium a reference to control objectives each of which may have encoded upon the computer readable medium a reference to risks each of which may have encoded upon the computer readable medium a reference to a plurality of control execution definitions each of which may have encoded upon the computer readable medium a reference to a control evaluation definition and to a plurality of control test definitions.

5. The definitions of claim 4 comprised of a plurality of process templates selected from a group consisting of an executable control, its tests, and its evaluation, each containing a frequency of application comprising common financial periods of interest, offsets against said period for when the control activity should start and be due, and such data elements as may be specified in the definition to be combined with a common process template or application container upon a targeted user's computer system modifying the operation of that system to display certain visual elements and to configure certain programmatic elements of the process template.

6. The process template of claim 5, further coupled to a compliance rules user selection screen via a plurality of visual elements to select programmatic elements into the process template thereby modifying the mathematical calculations or comparisons of a plurality of data elements.

7. The context structure of claim 2 comprising the unit hierarchy of users responsible for performing activities selected from the group consisting of creating, performing, evaluating, and testing the controls, said responsibility being assigned individually or by means of the control hierarchy wherein a level of the control hierarchy may be assigned to an individual in the unit hierarchy who shall be the default performer of every control below that level of control or said assignment overridden by further assignment by category or by specific assignment to an element lower in that control hierarchy and further specifying a person in the unit whom the scheduler will contact in the event of a failure or delay of an assigned individual in performing a control in a timely manner.

8. The micro application container of claim 2 comprising a unique configuration of visual and programmatic elements driven by the data referenced in a definition, creating for each user and for each control, each evaluation, and each test, a temporary, locally-saved interactive client which offloads the server from processing other than delivery of the process template to the client, the delivery of the process template data which arranges an endless combination of visual and programmatic elements and, subsequently, recordation of the submitted results.

9. The routing engine of claim 2 comprised of a mechanism to look up the target unit and associated users coupled to a mechanism for authentication using a directory service thereby obtaining an email address coupled to a mechanism to record or update a transaction in a database coupled to a mechanism for sending notification to the target with a url link to the transaction in the database coupled to a mechanism to respond to a user click on the url by transmitting process template and process template data specified within an element of the definitional hierarchy electronically to the user's client where the process template data uniquely configures the process template for display, interaction and acknowledging subsequent submittal and recording submitted data.

10. The scheduler of claim 1 further comprising a mechanism of operating against financial periods rather than dates so that in any given year, the controls may be scheduled automatically around holidays and weekends, and further comprising a mechanism of offsetting the launch of processes by a start offset and measuring performance against a due offset specified in days relative to the financial period to provide the user notification, reminders, and if needed initiate an escalation process, and further comprising a mechanism to catch-up both for completely missed days as well as partially missed days where partial completion of the scheduler's task was accomplished prior to an outage, and further comprising a mechanism for checking for active transactions which require multiple steps and the established timelimit for each step in order to measure unacceptably slow progress and automatically move the assignment to an alternate performer.

11. A method for documenting, performing, and attesting to internal controls of a public or private entity or enterprise comprising the steps of first scheduling the processing of a selected list of business control definitions, second notifying selected performers in a unit structure of their required activity within a time period, third routing the necessary process template and process template data comprising information, instructions, buttons, applications, fields, and references deemed useful for the defined activity, fourth, recording the performer's submittal of the business control activity by operating on the process template and process template data, and fifth, preparing the supporting materials for officers of the corporation to assert and external auditors to attest that adequate financial controls meet regulatory requirements wherein, scheduling the processing of a selected list of business control definitions comprises the following steps: comparing the current scheduler day and time of day against the last successful run to determine if it is necessary to schedule processes, selecting one of a plurality of process types from a group consisting of controls, evaluations, and tests, selecting one of a plurality of frequencies from a group consisting of hourly, daily, weekly, monthly, quarterly, and annually, matching definitions against the selected process type and frequency, computing the start offset for each definition and comparing to the current scheduler date, comparing the last successful run date for each definition against the current scheduler date, identifying the business unit linked to each selected definition, reading the default user assignment for each business unit, checking if the definition overrides this specific assignment, and routing the process to the assigned user, proceeding in turn to the next unit identified in the definition until all are processed, proceeding in turn to the next definition until all are processed, proceeding in turn to the next frequency until all are processed, proceeding in turn to the next type until all are processed, and setting the scheduler date to the last successful run date plus one increment and reiterating until the current scheduler date exceeds the computer system current date.

12. The method of automating an internal control system comprising firstly creating a definitional hierarchy structure, secondly creating a plurality of context structures, thirdly creating a plurality of context data category lists, fourthly scheduling according to process template data, fifthly routing process template data and process templates to dynamically synthesize, transmit, and read micro application containers presented to and submitted by a plurality of users as uniquely directed by the process template data of each definition.

13. The method of defining and populating a context data category of claim 12 comprising the steps of creating lists of previously created context data categories or lists of context data structures wherein said context data category associates disparate context items that may or may not be related by context type or by their location in a hierarchy but which may be efficiently linked to either the definitional or unit hierarchies by a single assignment from any level of the respective hierarchies to the context data category comprising the appropriate references, units, values, standard errors, assertions and any member of the set of context data.

14. The method of configuring a definitional hierarchy structure of claim 12 comprising the steps of selecting and then naming a plurality of major areas and for each major area selecting and naming a plurality of accounting processes and for each accounting process selecting and naming a plurality of accounting sub-processes and for each accounting sub-process, selecting and naming a plurality of control objectives and for each control objective selecting and naming a plurality of risks and for each risk, naming and specifying a plurality of control execution definitions and for each control execution definition, naming and specifying a plurality of control evaluation definitions and control test definitions.

15. The method of creating the definitions of claim 14 comprised of the steps of selecting a frequency of application from a list of common financial periods of interest, selecting an offset against said period for when the control activity should start and be due, adding a name and description, selecting visual elements and captions, specifying data types for input field and data elements for display thereby creating a process template and specifying the process template data that will configure the process template or application container upon a targeted user's computer system modifying the operation of that system to display certain visual elements and to configure certain programmatic elements of the process template.

16. The method of building a process template of claim 15 further comprising the steps of accessing a compliance rules user selection screen, secondly, clicking a plurality of visual elements to select programmatic elements into the process template and thirdly modifying the mathematical calculations or comparisons of a plurality of data elements by incorporating the selected programmatic modules into the template.

17. The method of creating a context structure of claim 12 comprising the steps of first, creating a unit hierarchy by specifying users responsible for creating, performing, evaluating, testing the controls within sub-units, and by specifying a plurality of sub-units within units in a hierarchical fashion and secondly adding other information relevant to the operation and analysis of a plurality of controls, their evaluation, and tests.

18. The method of using a process template to synthesize the display of a micro application container of claim 12 comprising the steps of reading a definition and upon request of the user, retrieving a unique configuration of visual and programmatic elements driven by the data referenced in a definition, and transmitting the visual and programmatic elements to the client workstation, creating for each user and for each control, each evaluation, and each test, a temporary, locally-saved interactive client which offloads the server from processing other than delivery of the process template to the client, the delivery of the process template data which arranges an endless combination of visual and programmatic elements and, subsequently, recordation of the submitted results.

19. The method of routing of claim 12 comprised of the following steps firstly looking up the target unit and associated users, secondly authenticating the user using a directory service thereby obtaining an email address, thirdly, recording or updating a transaction in a database, fourthly, sending notification to the target with a url link to the transaction in the database, fifthly responding to a user click on the url by transmitting process template and process template data specified within an element of the definitional hierarchy electronically to the user's client, sixthly uniquely configuring the process template for display, interaction and seventhly, acknowledging subsequent submittal and recording submitted data.

20. The method of scheduling of claim 11 further comprising firstly operating against financial periods rather than dates so that in any given year, the controls may be scheduled automatically around holidays and weekends, and secondly computing the date of launch of processes by a start offset and measuring performance against a due offset specified in days relative to the financial period to provide the user notification, reminders, and if needed initiate an escalation process, and thirdly initiating additional processes to catch-up both for completely missed days as well as partially missed days where partial completion of the scheduler's task was accomplished prior to an outage, and fourthly checking for active transactions which require multiple steps and the established timelimit for each step in order to measure unacceptably slow progress and fifthly automatically moving the assignment to an alternate performer.

21. An internal control system for documenting, performing, and attesting to internal controls of a public or private entity or enterprise comprising a scheduling system which selects from a list of business control definitions, a routing system which notifies selected performers in a unit structure of their required activity within a time period, and transmits the necessary process template and process template data comprising information, instructions, buttons, applications, fields, and references deemed useful for the defined activity, a transaction system which monitors the performer's submittal of the business control activity by operating on the process template and process template data, and a reporting system to prepare the supporting materials for officers of the corporation to assert and external auditors to attest that adequate financial controls meet regulatory requirements wherein, said scheduling system directs the operation of the computer system as follows: comparing the current scheduler day and time of day against the last successful run to determine if it is necessary to schedule processes, selecting one of a plurality of process types selected from a group consisting of controls, evaluations, and tests, selecting one of a plurality of frequencies from a group consisting of hourly, daily, weekly, monthly, quarterly, and annually, matching definitions against the selected process type and frequency, computing the start offset for each definition and comparing to the current scheduler date, comparing the last successful run date for each definition against the current scheduler date, identifying the business unit linked to each selected definition, reading the default user assignment for each business unit, checking if the definition overrides this specific assignment, and routing the process to the assigned user, proceeding in turn to the next unit identified in the definition until all are processed, proceeding in turn to the next definition until all are processed, proceeding in turn to the next frequency until all are processed, proceeding in turn to the next type until all are processed, and setting the scheduler date to the last successful run date plus one increment and reiterating until the current scheduler date exceeds the computer system current date.

22. The internal control system of claim 21 wherein a definitional hierarchy database, is linked to a plurality of context databases and to a plurality of context data category lists, and communicates with said scheduling system by means of process template data, which further provides a routing system with process template data to dynamically synthesize, transmit, and read micro application containers presented to and submitted by a plurality of users as uniquely directed by the process template data of each definition.

23. The context data category of claim 22 containing elements selected from the group consisting of further lists of context data categories, lists of context data structures, references, units, values, standard errors, and assertions.

24. The definitional hierarchy structure of claim 22 comprising elements selected from a group consisting of major areas, accounting processes, accounting sub-processes, control objectives, risks, control execution definitions, control evaluation definitions and control test definitions.

25. The definitions of claim 24 consisting of process templates selected from the group consisting of executable controls, tests, and evaluations containing a frequency of application comprising common financial periods of interest, offsets against said period for when the control activity should start and be due, visual elements, data, and programmatic elements.

26. The process template of claim 25, further coupled to a compliance rules user selection screen via a plurality of visual elements to select programmatic elements into the process template thereby modifying the mathematical calculations or comparisons of a plurality of data elements.

27. The context structure of claim 22 selected from the group consisting of the unit hierarchy of users responsible for creating, performing, evaluating, or testing the controls, and a person in the unit whom the scheduler will contact in the event of a failure or delay of an assigned individual to perform a control in a timely manner.

28. The micro application container of claim 22 comprising means for configuring visual and programmatic elements driven by the data referenced in a definition, means for creating for each user and for each control, evaluation, or test, a temporary or locally saved interactive client which offloads the server from processing other than delivery of the process template to the client, means for delivering the process template data which arranges an endless combination of visual and programmatic elements and, means for recording of the submitted results.

29. The routing system of claim 22 comprised of means for looking up the target unit and associated users coupled to means for authentication using a directory service thereby obtaining an email address coupled to means for to record or update a transaction in a database coupled to a mechanism for sending notification to the target with a url link to the transaction in the database coupled to a mechanism to respond to a user click on the url by transmitting process template and process template data specified within an element of the definitional hierarchy electronically to the user's client where the process template data uniquely configures the process template for display, interaction and acknowledging subsequent submittal and recording submitted data.

30. The scheduling system of claim 21 further comprising means for operating against financial periods rather than dates so that in any given year, the controls may be scheduled automatically around holidays and weekends, and means for offsetting the launch of processes by a start offset and measuring performance against a due offset specified in days relative to the financial period to provide the user notification, reminders, and if needed initiate an escalation process, and means for catching-up both for completely missed days as well as partially missed days where partial completion of the scheduler's task was accomplished prior to an outage, and means for checking for active transactions which require multiple steps and the established timelimit for each step in order to measure slow or no progress and automatically moving the assignment to an alternate performer.
